(19) United States
(12) Patent Application Publication
(10) Pub. No.: US 2011/0302464 A1
(43) Pub. Date: Dec. 8, 2011

(54) DIGITAL DATA TRANSMISSION SYSTEM USING TRANSMITTING UNIT AND RECEIVING UNIT AND TRANSMISSION METHOD

(76) Inventor: TSUGIO TAKAHASHI, Tokyo (JP)

(21) Appl. No.: 13/151,839

(22) Filed: Jun. 2, 2011

(30) Foreign Application Priority Data
Jun. 8, 2010 (JP) 2010-130858

(51) Int. Cl. G06F 11/07

(52) U.S. Cl. 714/700; 714/E11.023

(57) ABSTRACT

A digital data transmission system includes a transmission unit and a reception unit. The transmission unit includes: a transmission-side logic section configured to transmit digital data in parallel onto data lines; and a deskew data generating section configured to transmit deskew data onto a deskew signal line. The deskew data includes sample data and parity data for each of line components of the digital data. The reception unit includes: a skew adjusting section configured to perform deskew processing on the digital data recovered from the data transmitted on the data lines based on the deskew data recovered from the data transmitted on the deskew signal line; an error correcting section configured to perform error correction on the recovered digital data subjected to the deskew processing based on the parity data of the recovered deskew data; and a reception-side logic section configured to execute a predetermined process to the recovered digital data subjected to the error correction.

### INCORPORATION BY REFERENCE

This patent application claims a priority on convention based on Japanese Patent Application No. 2010-130858. The disclosure thereof is incorporated herein by reference.

### TECHNICAL FIELD

The present invention is related to a digital data transmission system which transmits and receives a parallel signal.

### BACKGROUND ART

SFI-5 (Serdes Framer Interface Level 5) standard is a standard for parallel communication interface in digital data transmission between LSI (Large Scale Integration) circuits. The SFI-5 standard is standardized in OIF (Optical Internetworking Forum).

Hereinafter, a digital data transmission system based on the SFI-5 standard will be described. FIG. 1 is a diagram showing a configuration of the digital data transmission system based on the SFI-5 standard. The digital data transmission system shown in FIG. 1 is provided with a transmission LSI circuit 101 and a reception LSI circuit 102.

The transmission LSI circuit 101 and the reception LSI circuit 102 are connected by a wiring section 103. The wiring section 103 contains data lines for digital data DATA[15:0] and a deskew signal line for deskew data DSC. The data lines of 16 lines are used to transmit digital data in parallel between the transmission LSI circuit 1 and the reception LSI circuit 2. The deskew data is used for performing deskew processing in the reception LSI circuit 2.

The transmission LSI circuit 1 is provided with a transmission-side core logic section 111, a framing controller section 114, a sample data extracting section 115 and a deskew data output section 116.

The transmission-side core logic section 111 outputs digital data DATA[15:0] onto the data lines in parallel. The framing controller section 14 controls the sample data extracting section 15 and the deskew data output section 16 to perform the framing of the deskew data DSC. Also, the framing controller section 14 outputs a header of the deskew data DSC. The sample data extracting section 15 extracts sample data for the deskew data DSC from the digital data DATA[15:0] on the data lines under the control of the framing controller section 14. The deskew data output section 16 outputs the header for the deskew data DSC and the sample data onto the deskew signal line under the control of the framing controller section 14.

FIG. 2 shows timing charts in the correspondence of the digital data DATA[15:0] on the data lines based on the SFI-5 standard and the deskew data DSC on the deskew signal line.

The framing controller section 14 controls the deskew data output section 16 to output the header of the deskew data DSC onto the deskew signal line. The header of the deskew data DSC includes 2-byte A1, 2-byte A2 and 4-byte EH1-4. Subsequently, the framing controller section 14 controls the sample data extracting section 15 to extract the sample data from line digital data of the digital data on each of the data lines while the data lines are sequentially changed for every 64 bits. The framing controller section 14 controls the deskew data output section 16 to transmit the extracted sample data subsequent to the header.

When the deskew data output section 16 completes the transmission of the sample data onto the deskew signal line, the framing controller section 14 controls the deskew data output section 16 to transmit a next frame. In this way, the deskew data for one frame (136 bytes=1088 bits) contains the header and the sample data for each of the digital lines.

FIG. 3 is a diagram showing a frame configuration of the deskew data based on the SFI-5 standard. As mentioned above, the 64-bit data of 2-byte A1, 2-byte A2 and 4-byte EH1-4 is transmitted as the header of the deskew data DSC. Subsequently, the sample data extracted from the line digital data for each of the data lines is transmitted while the data lines are sequentially changed for every 64 bits.

Next, referring to FIG. 1 again, the reception LSI circuit 102 is provided with a clock data recovery (CDR) section 121, a deskew controller section 125, a variable delay section 126 and a reception-side core logic section 124.

The CDR section 121 performs clock recovery processing and data recovery processing on digital data DATA[15:0] received from the data lines and the deskew data DSC received from the deskew signal line. The CDR section 21 outputs the deskew data recovered by the clock recovery processing and the data recovery processing to the deskew controller section 125, and outputs the received digital data to the'variable delay section 126.

The deskew controller section 125 receives the received digital data DATA[15:0] and the deskew data DSC from the CDR section 21. The deskew controller section 125 detects the header of the deskew data. Next, the deskew controller section 125 extracts the sample data for the data lines from the received deskew data. The deskew controller section 125 compares the sample data for each data line and line digital data, corresponding to the data line, of the digital data DATA[15:0] received from the CDR section 21. Thus, the deskew controller section 125 detects a delay amount of the line digital data of the received digital data DATA[15:0] through this comparison processing.

The variable delay section 126 performs deskew processing on line digital data of the received digital data DATA[15:0] for the data line based on the delay amount detected by the deskew controller section 125. The variable delay section 126 outputs the received digital data subjected to the deskew processing to the reception-side core logic section 24. The reception-side core logic section 24 performs predetermined processing by using the received digital data. In more detail, the SFI-5 standard by OIF should be referred to.

In recent years, a bit rate in the digital data transmission between the LSI circuits as in the SFI-5 standard is increasing. For example, in the SFI-5 standard, the transmission speed of 2.5 Gbps is defined for every data line to permit the digital data transmission of 40 Gbps by 16 data lines. However, in the digital data transmission in which the digital data is transmitted in parallel, a frequency of error generation in the digital data becomes higher, as the bit rate is increased.

For this reason, attention is paid sufficiently to wiring design of a printed circuit board, and transmission simulation is carefully performed. However, even if the influence of a variation of impedance of the printed circuit board and a variation of termination resistance are considered, realization of error free transmission is not easy. Also, there is a similar case even if the bit rate is not as high as a few Gbps in data transmission. For example, when a signal transmission distance is long or a connector is inserted on the way, degradation of a signal waveform is large, and realization of error free transmission is not easy.

In the design of high-speed interface between LSI circuits, an error is often discovered in the digital data in an evaluating process of the printed circuit board. In this case, a return to the design process of the printed circuit board introduces increase in a design expense and a design period. Therefore, the realization of error correction in the reception-side LSI circuit is requested from both of reduction of the design expense and shortening of the design period.

Patent Literature 1 discloses a signal transmission circuit in which an error correction is performed in parallel signal transmission. The signal transmission circuit of Patent Literature 1 generates an error correction code from transmission data for every constant bit length. The error correction codes are connected in serial and are transmitted on a transmission path. The error correction codes transmitted in serial are compared with error correction codes generated based on the reception data, in a reception side. Through this comparison, error correction is performed for every constant bit length for every bit. According to the signal transmission circuit of Patent Literature 1, the error correction is possible in the reception-side. However, a data path to transmit the error correction code is necessary, separately from data paths to transmit the digital data.

Also, Patent Literature 2 discloses a technique of synchronization of data on a plurality of data lines by using a deskew signal line in relation to the SFI-5 standard.

### CITATION LIST

[Patent Literature 1]: JP H10-294720A
[Patent Literature 2]: JP 2009-500920A

### SUMMARY OF THE INVENTION

The present invention is to provide a digital data transmission system in which error correction can be performed on digital data on a reception side without increasing a bit rate of the digital data.

In an exemplary aspect of the present invention, a digital data transmission system includes a transmission unit and a reception unit. The transmission unit includes: a transmission-side logic section configured to transmit digital data in parallel onto data lines; and a deskew data generating section configured to transmit deskew data onto a deskew signal line. The deskew data includes sample data and parity data for each of line components of the digital data. The reception unit includes: a skew adjusting section configured to perform deskew processing on the digital data recovered from the data transmitted on the data lines based on the deskew data recovered from the data transmitted on the deskew signal line; an error correcting section configured to perform error correction on the recovered digital data subjected to the deskew processing based on the parity data of the recovered deskew data; and a reception-side logic section configured to execute a predetermined process to the recovered digital data subjected to the error correction.

In an exemplary aspect of the present invention, a digital data processing method is achieved by transmitting digital data in parallel onto data lines; by transmitting deskew data onto a deskew data line; wherein the deskew data comprises sets of sample data and parity data for each of line components of the digital data; by performing deskew processing on digital data recovered from data transmitted on the data lines based on the sample data; by correcting the recovered digital data subjected to the deskew processing based on the parity data; and by executing predetermined processing to the corrected digital data.

In an exemplary aspect of the present invention, a transmitting unit includes a transmission-side logic section configured to transmit digital data in parallel onto data lines; and a deskew data generating section configured to transmit deskew data onto a deskew signal line. The deskew data includes sample data and parity data for each of line components of the digital data.

In an exemplary aspect of the present invention, a receiving unit includes: a skew adjusting section configured to perform deskew processing on digital data recovered from data transmitted on data lines based on deskew data recovered from data transmitted on a deskew signal line; an error correcting section configured to perform error correction on the recovered digital data subjected to the deskew processing based on parity data of the recovered deskew data; and a reception-side logic section configured to execute a predetermined process to the recovered digital data subjected to the error correction.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a convention digital data transmission system based on SFI-5 standard;

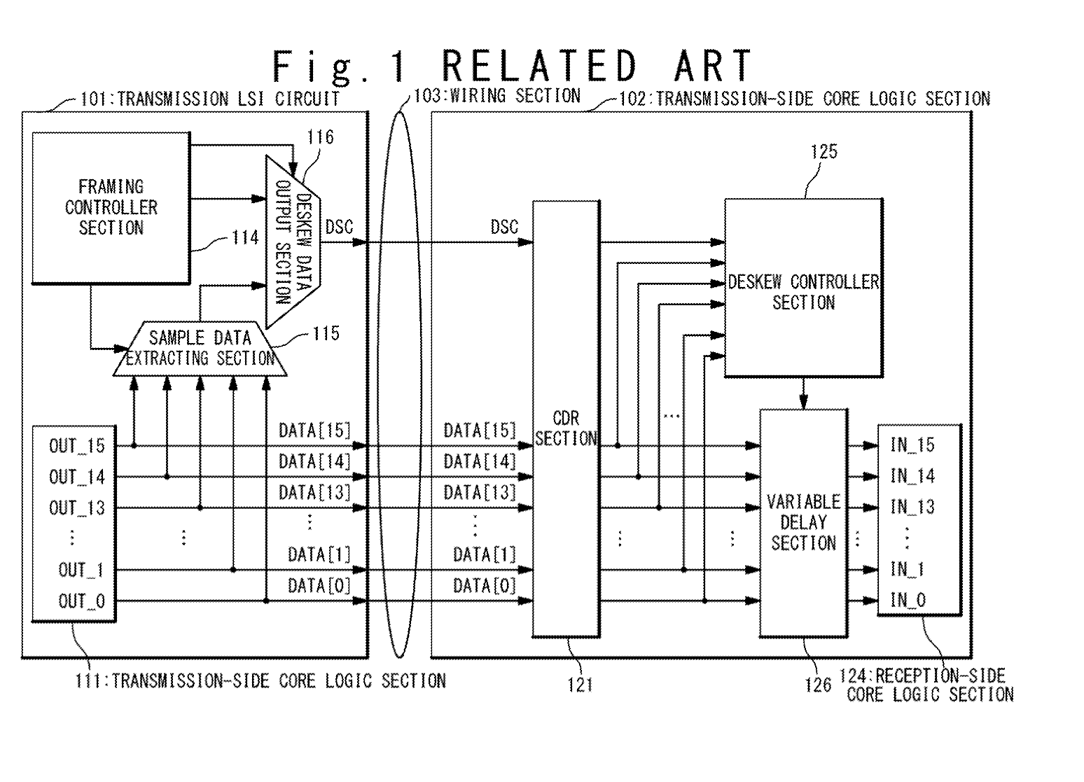

FIG. 2 shows timing charts of digital data DATA[15:0] transmitted on data lines based on the SFI-5 standard and deskew data DSC transmitted on a deskew signal line;

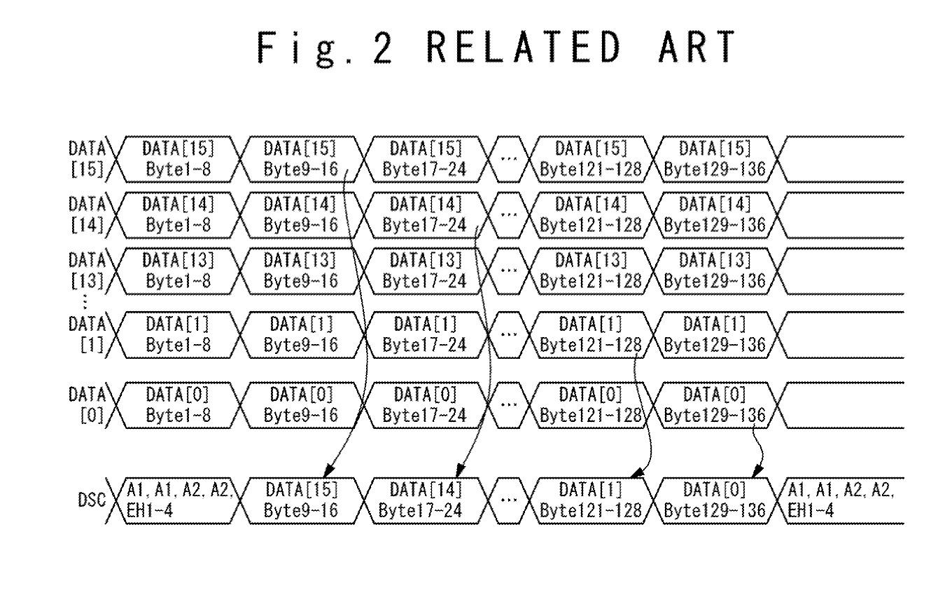

FIG. 3 is a diagram showing a frame configuration of the deskew data DSC based on the SFI-5 standard;

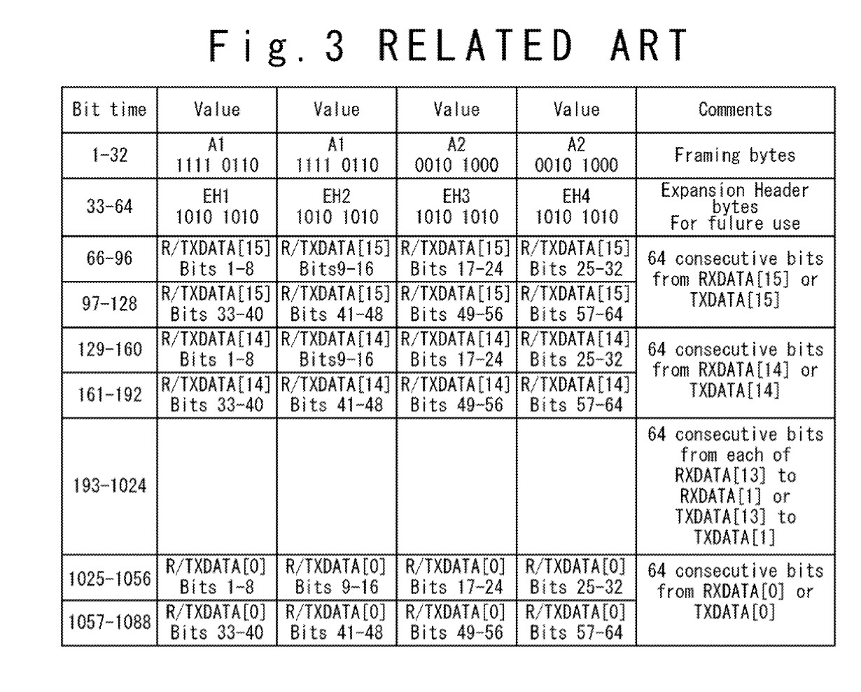

FIG. 4 is a block diagram showing a configuration of a digital data transmission system according to a first exemplary embodiment of the present invention;

FIG. 5 is a block diagram showing a configuration of an FEC encoder section in the digital data transmission system according to the first exemplary embodiment of the present invention;

FIG. 6 is a block diagram showing a configuration of an FEC decoder section in the digital data transmission system according to the first exemplary embodiment of the present invention;

FIG. 7 is a block diagram showing a configuration of a correction processing section in the digital data transmission system according to the first exemplary embodiment of the present invention;

FIG. 8 is a truth table showing input-output relation of an adder in the digital data transmission system according to the first exemplary embodiment of the present invention;

FIG. 9 shows timing charts in a relation of digital data and deskew data in the digital data transmission system according to the first exemplary embodiment of the present invention;

FIG. 10 is a diagram showing a relation between a data length of test data and a bit length of Hamming code when the Hamming code is used for the error correction in the first exemplary embodiment of the present invention;

FIG. 11 shows timing charts in a relation of digital data and deskew data in the digital data transmission system according to a second exemplary embodiment of the present invention.

### DESCRIPTION OF EXEMPLARY EMBODIMENTS

Hereinafter, a digital data transmission system of the present invention will be described below in detail with reference to the attached drawings.

### First Exemplary Embodiment

First, the digital data transmission system according to a first exemplary embodiment of the present invention will be described.

The digital data transmission system of the present exemplary embodiment is provided with a transmission LSI (Large Scaled Integration) circuit 1 and a reception LSI circuit 2. The transmission LSI circuit 1 and the reception LSI circuit 2 are connected by a wiring section 3. The wiring section 3 contains data lines and a deskew signal line. The data lines of 16 signal lines are used to transmit line components of digital data in parallel from the transmission LSI circuit 1 to the reception LSI circuit 2. The deskew signal line of a signal line is used to transmit deskew data DSC which is used to adjust a skew of each of the line components of the digital data received by the reception LSI circuit 2, and correct any errors of the line component.

The transmission LSI circuit 1 will be described. The transmission LSI circuit 1 is provided with a deskew data generating section 10 and a transmission-side core logic section 11. The transmission-side core logic section 11 outputs the line components of the digital data onto the data lines in parallel. The deskew data generating section 10 generates and transmits the deskew data DSC onto the deskew signal line. The deskew data generating section 10 is provided with an FEC (Forward Error Correction) encoder section 12, a framing controller section 14, a sample data extracting section 15 and a deskew data output section 16.

The framing controller section 14 controls the FEC encoder section 12, the sample data extracting section 15 and the deskew data output section 16 to perform a framing of the deskew data. The framing controller section 14 outputs a header of the deskew data to the deskew data output section 16.

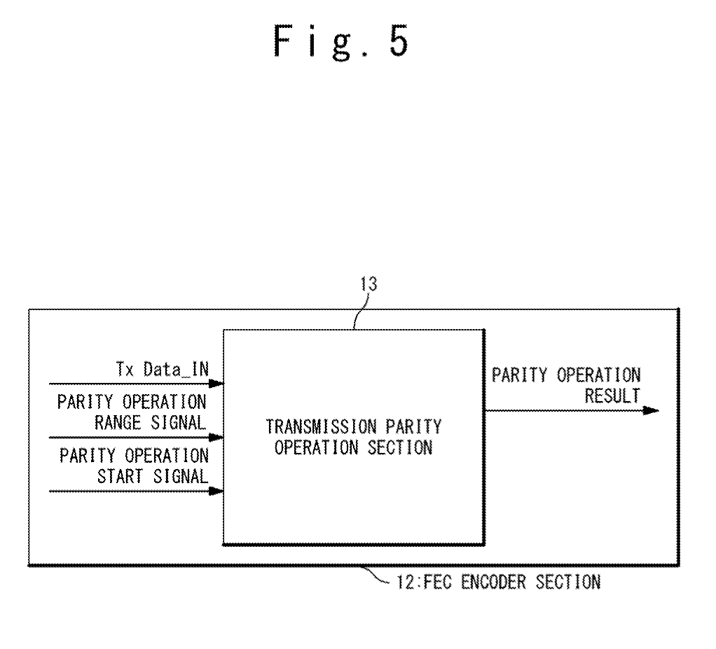

The FEC encoder section 12 is provided with parity operation sections 13 for the data lines. Because the parity operation sections 13 have a same configuration and operate in a same manner. Therefore, only one of the parity operation sections 13 is shown in FIG. 5. The parity operation section 13 calculates a portion of a code correction data (hereinafter, to be referred to as a parity data (PTY) portion) from each of the line components of the digital data DATA[15:0]. The parity operation section 13 receives the line component of the digital data (Tx DATA_IN) from the corresponding one of the data lines. Also, the parity operation section 13 receives a parity operation range signal and a parity operation start signal from the framing controller section 14. The parity operation start signal is a signal to specify the start of a parity operation. The parity operation range signal is a signal to specify a range of the digital data on which the parity operation is performed. The parity operation section 13 performs the calculation of parity data for the corresponding line component of the digital data in a range specified by the parity operation start signal and the parity operation range signal. The parity operation section 13 outputs the parity data as a parity operation result together with the digital data to the sample data extracting section 15.

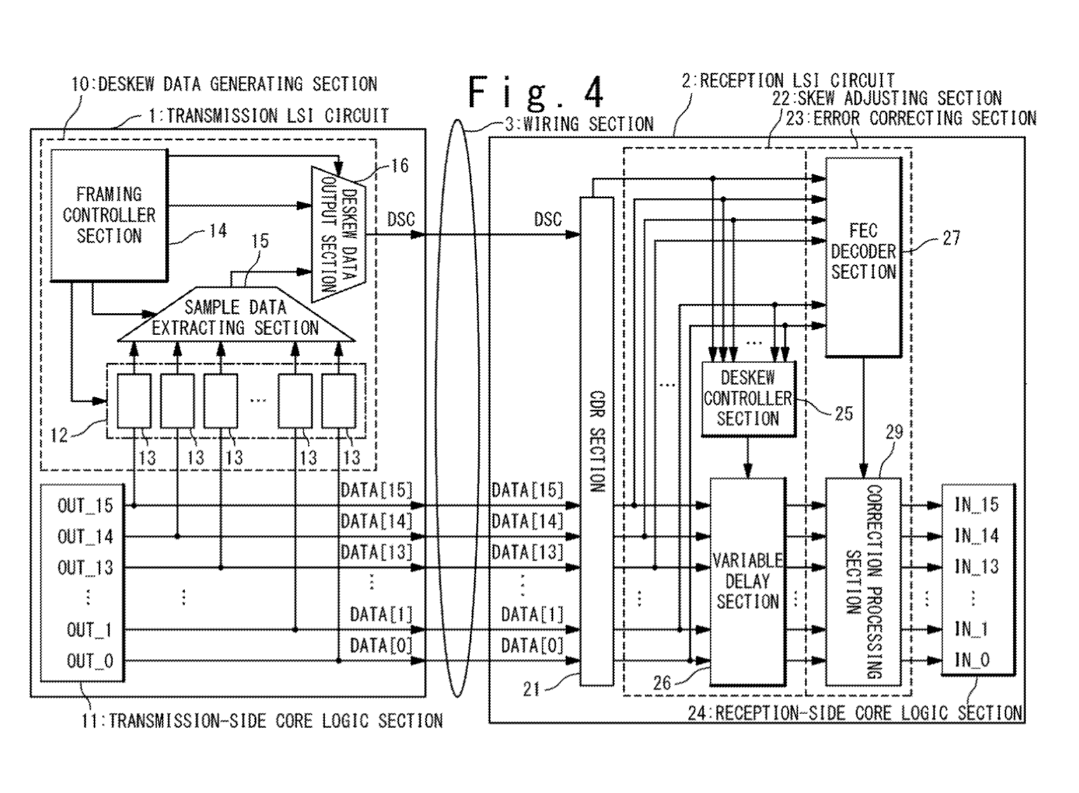

Referring to FIG. 4 again, the sample data extracting section 15 extracts sample data from the line component of the digital data on each of the data lines, while sequentially selecting one of the data lines and outputs the sample data and the parity data related to the selected data line to the deskew data output section 16.

Next, the deskew data output section 16 selects a header of the deskew data received from the framing controller section 14 and then sets of the sample data and the parity data for the data lines received from the sample data extracting section 15, and outputs them onto the deskew signal line.

Next, the reception LSI circuit 2 will be described. The reception LSI circuit 2 is provided with a clock data recovery (CDR) section 21, a skew adjusting section 22, an error correcting section 23 and a reception-side core logic section 24.

The CDR section 21 performs clock recovery processing and data recovery processing on the data transmitted on the data lines and the deskew signal line, to recover the digital data and the deskew data DSC. The CDR section 21 outputs the recovered digital data and the recovered deskew data DSC to the skew adjusting section 22 and the error correcting section 23.

Next, the skew adjusting section 22 adjusts a skew of the recovered digital data based on the sample data contained in the recovered deskew data. The skew adjusting section 22 is provided with a deskew controller section 25 and a variable delay section 26. The deskew controller section 25 receives the recovered digital data and the recovered deskew data from the CDR section 21. The deskew controller section 25 detects a header of the recovered deskew data. Subsequently, the deskew controller section 25 extracts the sample data for each line component of the digital data from the recovered deskew data. The deskew controller section 25 compares the extracted sample data and the corresponding line component of the recovered digital data. The deskew controller section 25 detects a delay amount through this comparing processing. Next, the variable delay section 26 performs deskew processing on the recovered digital data based on the delay amounts for the line components detected by the deskew controller section 25. The variable delay section 26 outputs the recovered digital data subjected to the deskew processing to the error correcting section 23.

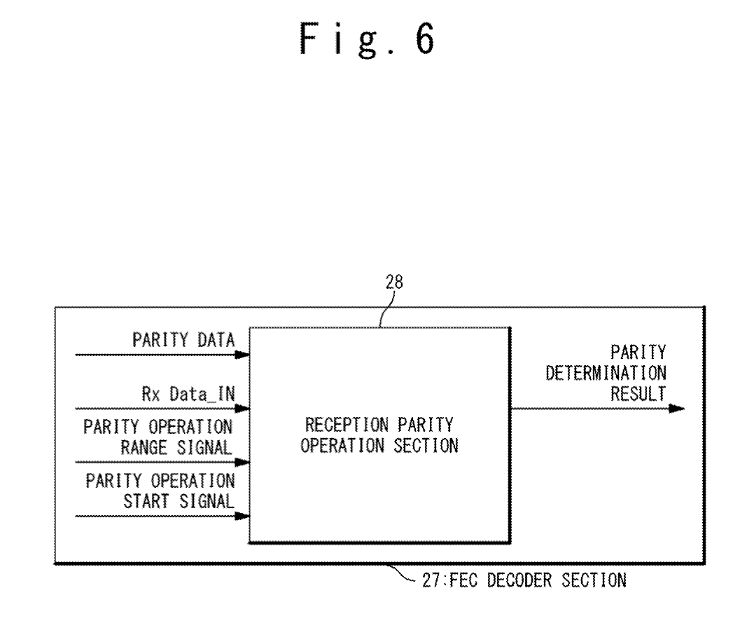

Next, the error correcting section 23 performs error correction on the recovered digital data by using the parity data of the recovered deskew data DSC. The error correcting section 23 is provided with an FEC decoder secLion 27 and a correcLion processing section 29. The FEC decoder section 27 performs error detection on the recovered digital data DATA[15:0]. FIG. 6 is a diagram showing the configuration of the FEC decoder section 27 of the present exemplary embodiment. The FEC decoder section 27 is provided with reception parity operation sections 28 for the data lines. The reception parity operation sections 28 have a same configuration and operate in a similar manner, and therefore, only one section 28 is shown in FIG. 6.

The FEC decoder section 27 extracts the parity data for each line component of the digital data, i.e. the parity data from the deskew data and outputs it to the reception parity operation section 28. Also, the reception parity operation section 28 receives the recovered digital data (Rx DATA_IN) from the CDR section 21. Moreover, the reception parity operation section 28 receives a parity operation range signal and a parity operation start signal. The parity operation start signal is a signal to specify start of the parity operation, and the parity operation range signal is a signal to specify a range of the recovered digital data on which the parity operation is performed. The parity operation range signal and the parity operation start signal are generated by the deskew controller section 25. The deskew controller section 25 can establish synchronization of the recovered digital data through the above-mentioned comparison processing.

The reception parity operation section 28 calculates the parity data from the recovered digital data based on the parity operation start signal and the parity operation range signal. Then, the reception parity operation sections 28 compare the calculated parity data and the extracted parity data portion. The reception parity operation section 28 outputs an error determination result according to the comparison processing result. The error determination result indicates a location of an error in the recovered digital data in the range specified by the parity operation start signal and the parity operation range signal. The reception parity operation section 28 outputs the error determination result indicating that there is no error in the recovered digital data, to the correction processing section 29 when the comparison processing result shows coincidence between the both. On the other hand, when the comparison processing result shows non-coincidence between the both, the reception parity operation section 28 outputs the error determination result indicating that there is an error in the recovered digital data, to the correction processing section 29.

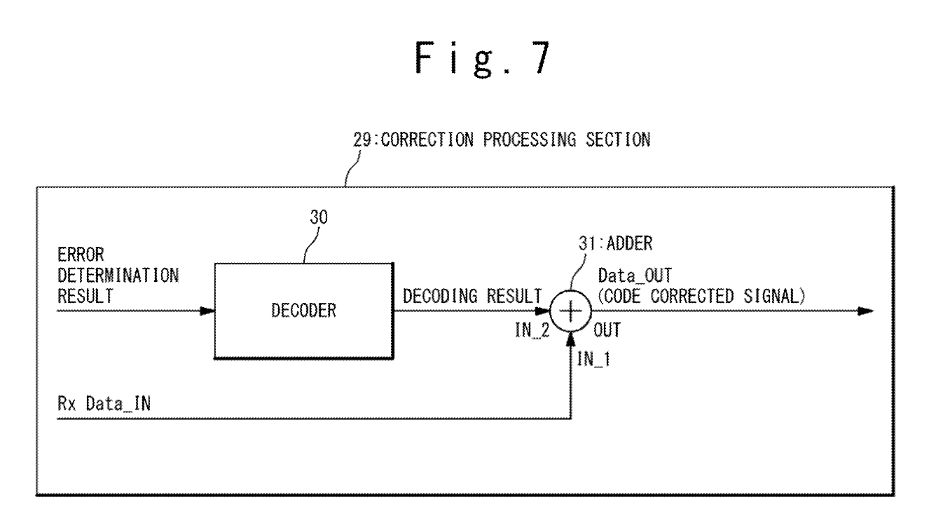

The correction processing section 29 corrects the recovered digital data based on the error judgment result from the FEC decoder section 27. FIG. 7 is a diagram showing the configuration of the correction processing section 29 in the present exemplary embodiment. The correction processing section 29 is provided with decoders 30 and an address 31 for the data lines. The decoder 30 receives the error determination result to the corresponding line component of the recovered digital data from the FEC decoder section 27. The decoder 30 specifies the location of the error in the recovered digital data based on the error determination result when the error determination result shows that there is the error. Thus, the decoder 30 outputs a decoding result showing the error location in a bit string of the recovered digital data to a corresponding one of the adders 31.

The adder 31 is an adder that has two inputs and one output, without a carry. The adder 31 receives at the input (IN_1) a corresponding portion of the recovered digital data (RxDATA_IN) subjected to the deskew processing by the variable delay section 26. Also, the adder 31 receives at the other input (IN_2) the decoding result from the decoder 30. The adder 31 outputs to the reception core logic section 24, a data portion whose bit of the recovered digital data specified by the error bit location shown by the decoding result is inverted.

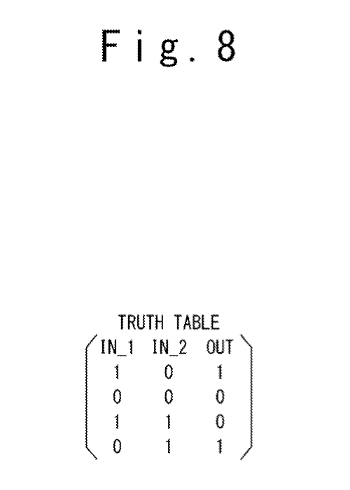

Here, FIG. 8 is a truth table showing a relation of inputs and output in the adder 31 of the present exemplary embodiment. Referring to FIG. 8, the adder 31 outputs a bit of the recovered digital data just as it is when the decoding result shows no error (bit of “0”). On the other hand, when the decoding result shows that there is an error (bit of “1”) in the bit of the received digital data, the adder 31 inverts the concerned bit of the recovered digital data and outputs the inverted result. In this way, the correction processing section 29 corrects the received digital data.

Next, the reception-side core logic section 24 receives the recovered digital data subjected to the error correction. The reception-side core logic section 24 performs predetermined processing by using the received digital data.

The transmission LSI circuit 1 of the present exemplary embodiment calculates the parity data from the line component of the digital data for each of the data lines. The transmission LSI circuit 1 transmits the sample data for the line component of the digital data and the parity data for the line component. Also, the reception LSI circuit 2 calculates the parity data from the digital data. Then, the reception LSI circuit 2 performs the error detection on the recovered digital data based on the parity data extracted from the deskew data, and the calculated parity data portion. The reception LSI circuit 2 performs the error correction by inverting only an error detection bit of the recovered digital data. Thus, the error correction of the digital data transmitted in parallel between the transmission LSI circuit 1 and the reception LSI circuit 2 is made possible.

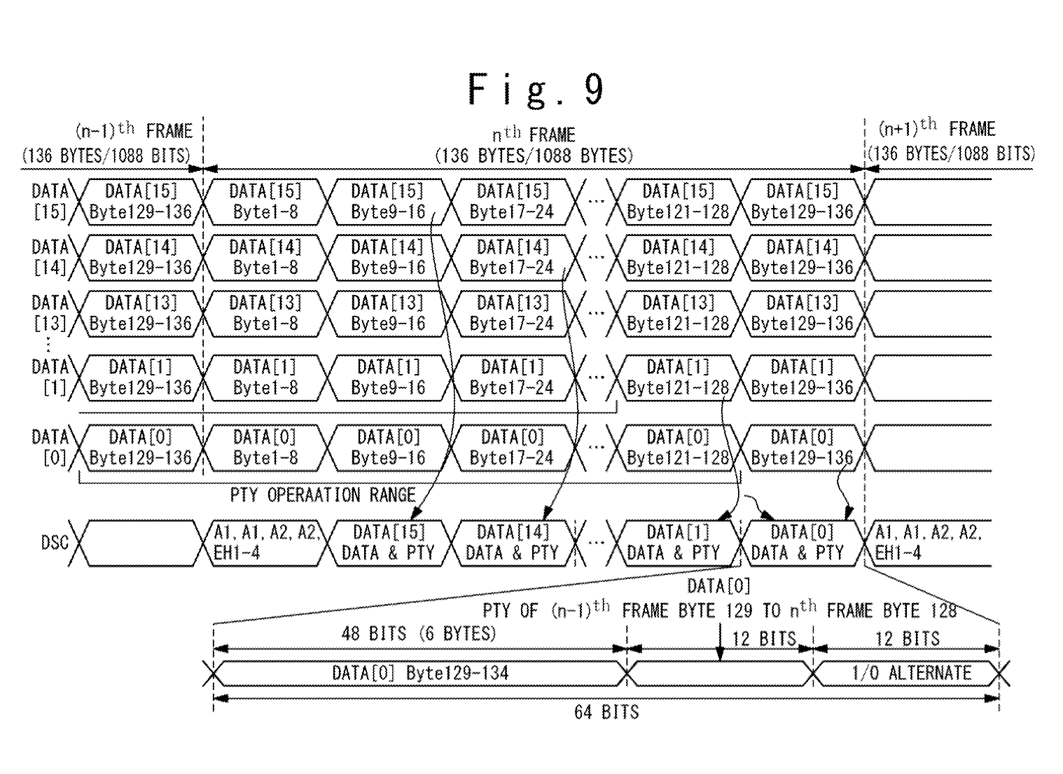

Next, an operation of the digital data transmission system of the present exemplary embodiment will be described. FIG. 9 shows timing charts in relation of the digital data and the deskew data in the digital data transmission system of the present exemplary embodiment. Referring to FIG. 9, an operation of the transmission LSI circuit 1 will be described.

In FIG. 9, the line components DATA[15] to DATA[0] of the digital data DATA[15:0] are transmitted in parallel on the data lines. Also, data DSC indicates deskew data DSC transmitted on the deskew signal line. In the SFI-5 standard, the digital data and the deskew data are subjected to the framing for every 136 bytes (1088 bits). The transmission-side core logic section 11 transmits Byte1 to Byte136 of the digital data onto the data lines in an n^{th} frame.

At the same time, the framing controller section 14 outputs an 8-byte header of the deskew data for the n^{th} frame. As mentioned above, 2-byte A1, 2-byte A2, and 4-byte of EH1-4 are contained in the header of the deskew data. At this time, the framing controller section 14 controls the deskew data output section 16 to select and output the header outputted from the framing controller section 14 onto the deskew signal line.

Next, the framing controller section 14 controls the FEC encoder section 12, the sample data extracting section 15 and the deskew data output section 16 to sequentially select one of the line components of the digital data, to generate the parity data for the selected line component, to extract the sample data from the line component, and to transmit the sample data and the parity data onto the deskew signal line.

Data storage areas are assigned to the deskew data in units of 64 bits. The sample data (48 bits) and the parity data (12 bits) for every line component are stored in the data storage area for the line component. Although 4 bits remain as unused bits, it is desirable to store an alternate pattern of “1” and “0” to avoid continuation of identical bit data.

The data storage area of the deskew data in the n″ frame for the line component DATA [0] is shown in FIG. 9. “Byte129 to Byte134” are first stored in the data storage area as the sample data extracted from the line component DATA[0]. Subsequently, the parity data (12 bits) calculated based on the digital data (136 bytes) for one frame immediately before the line component DATA[0] of the digital data is stored. In other words, the parity data is calculated based on 136 bytes from “Byte129” of the line component of the digital data in the (n−1)^{th} frame to “Byte128” in the n^{th} frame. Moreover, the alternate pattern of “1” and “0” is stored in the unused 4 bits. In this way, the data storage area of the deskew data corresponding to the line component DATA[0] in the n^{th} frame is generated.

Also, the storage data for another line component is prepared in the same way. In the data storage area corresponding to the line component DATA[15] which is inserted immediately after the header of the deskew data, “Byte9 to Byte14” (48 bits) for the line component DATA[15] as the sample data, the parity data of 12 bits calculated based on the 136 bytes from “Byte17” of the digital data for the data DATA[15] in the (n−1)^{th} frame to “Byte8” of the n^{th} frame, and unused 4 bits of the alternate pattern of “1” and “0” are stored.

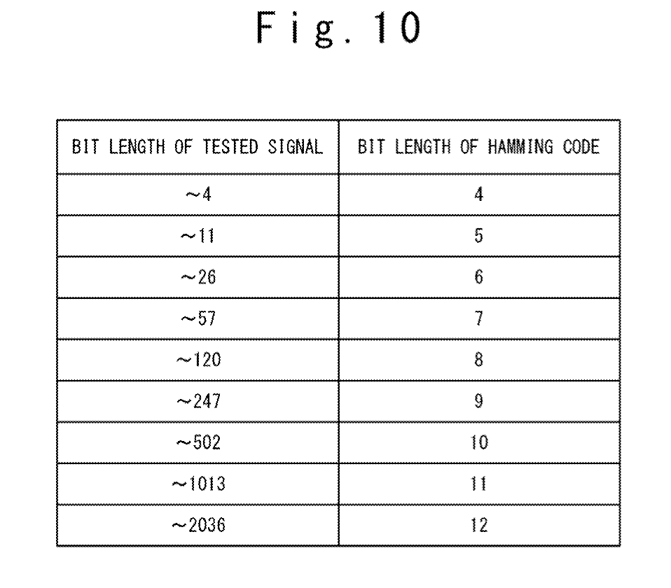

It should be noted that in the present exemplary embodiment, a Hamming code is used for a code correction method. The Hamming code can perform a 1-bit error correction to tested data. Also, the Hamming code can be used to detect a 2-bit error but cannot be used to correct. FIG. 10 is a diagram showing a relation between a data length of the tested data and a bit length of the Hamming code when the Hamming code is used for the error correction in the present exemplary embodiment. Referring to FIG. 10, when the parity data is calculated based on 1088 bits (136 bytes) for one frame immediately before the sample data as in the present exemplary embodiment, it is shown to be sufficient that the bit length of the Hamming code is 12 bits.

It should be noted that the code correction method is not limited to the Hamming code. Another code correction method may be used. In this case, a bit length of the parity data depends on the code correction method. Therefore, the sample data stored in the data storage area of the deskew data, the data length may be changed from 48 bits according to the code correction method.

The framing controller section 14 controls the sample data extracting section 15 to select one of the data lines and to extract the 48-bit sample data from the selected data line. Also, the framing controller section 14 specifies 136 bytes (1088 bits) as a range for one frame immediately before the sample data based on the parity operation start signal and the parity operation range signal, and controls each of the parity operation sections 13 to calculate the parity data. Then, the framing controller section 14 controls the sample data extracting section 15 and the deskew data output section 16 to output the 12-bit parity data as the parity operation results and unused 4 bits of the alternate pattern of “1” and “0” to the deskew signal line, subsequently to the 48-bit sample data.

In this way, the framing controller section 14 controls the FEC encoder section 12, the sample data extracting section 15 and the deskew controller output section 16 to transmit the deskew data DSC for one frame onto the deskew signal line.

It should be noted that in the present exemplary embodiment, the 48-bit area of the 64-bit data storage area for the deskew data is used to store the sample data. For this reason, as compared with a case that the case to store a 64-bit sample data and to perform the deskew processing, the degradation of the function of deskew processing in a case of the reception LSI circuit 2 is worried. However, an inventor of the present invention confirmed that there is not an influence in the property of the deskew processing in the reception LSI circuit 2, even if the sample data length which is stored in the data storage area is shortened. The inventor performed performance evaluation of the reception LSI circuit 2 when 32-bit sample data was stored in the 64-bit data storage area, by using an evaluator for a long term. In such a condition, the function deterioration of the deskew processing of the reception LSI circuit 2 was not detected at all.

Next, an operation of the reception LSI circuit 2 will be described. The reception LSI circuit 2 receives the reception signals from the deskew signal line and the data lines in the wiring section 3. The CDR section 21 performs the data recovery processing and the clock recovery processing on the reception signals and recovers the deskew data and the received digital data.

The deskew controller section 25 receives the recovered digital data and the recovered deskew data from the CDR section 21. The deskew controller section 25 detects the header of the deskew data. The deskew controller section 25 extracts the 48-bit sample data for each of the line components from a portion of the deskew data subsequent to the header. The deskew controller section 25 compares the sample data for each of the data lines and the recovered digital data for the corresponding data line. The deskew controller section 25 detects a delay amount of the recovered digital data for each of the data lines through the comparison processing.

The variable delay section 26 performs the deskew processing on the recovered digital data based on the delay amount detected by the deskew controller section 25. The variable delay section 26 outputs the recovered digital data subjected to the deskew processing in this way to the correction processing section 29.

The FEC decoder section 27 receives the recovered digital data and the deskew data from the CDR section 21. Each of the reception parity operation sections 28 in the FEC decoder section 27 extracts the parity data for the line component of the recovered digital data from the deskew data. Also, the reception parity operation sections 28 receive the recovered digital data from the CDR section 21.

The reception parity operation section 28 calculates the parity data portion from the recovered digital data based on the parity operation range signal and the parity operation start signal which are supplied from the deskew controller section 25. Then, the reception parity operation section 28 compares the calculated parity data and the received parity data acquired from the deskew data. The reception parity operation sections 28 outputs an error determination result to the correction processing section 29 to indicate “no error in the recovered digital data”, when the comparison result indicates coincidence, and outputs the error determination result to the correction processing section 29 to indicate “there is an error in the recovered digital data”, when the comparison result indicates non-coincidence.

The decoder 30 in the correction processing section 29 receives the error determination result for the line component from the FEC decoder section 27. The decoder 30 specifies the location of the error in the recovered digital data based on the error determination result when the error determination result indicates that there is an error. Then, the decoder 30 outputs the decoding result to the adder 31 to indicate the error location in a bit string of the recovered digital data.

The adder 31 in the correction processing section 29 receives the recovered digital data subjected to the deskew processing from the variable delay section 26 and the decoding result outputted from the decoder 30. The adder 31 inverts a bit of the error location specified by the decoding result to correct the data. The adder 31 outputs the corrected recovered digital data to the reception core logic section 24.

The reception-side core logic section 24 receives the corrected recovered digital data for the data lines. The reception-side core logic section 24 is provided with the inputs IN[15:0] for the data lines. The reception-side core logic section 24 performs predetermined processing by using the recovered digital data supplied to the input IN[15:0].

The framing controller section 14 stores the sample data and the parity data for the data lines in the data storage areas of the deskew data. The 64-bit data storage area is allocated to each of the data lines. The framing controller section 14 stores the sample data (48 bits) of the digital data for each of the data lines and the parity data (12 bits) calculated based on the digital data for each of the data lines.

The reception LSI circuit 2 extracts the sample data from the deskew data and performs the deskew processing on the recovered digital data for each of the data lines. Also, the reception LSI circuit 2 extracts the parity data from the deskew data and corrects the recovered digital data for each data lines.

In this way, in the digital data transmission system of the present exemplary embodiment, because the parity data is inserted in the deskew data which is transmitted, it is possible to correct the digital data transmitted in parallel without adding a signal line for the error correction data. Also, a data amount of the digital data never increases. Therefore, it is not necessary to increase the bit rate of the digital data.

In the digital data transmission system of the present exemplary embodiment, it is possible to correct the digital data by using parity data. Therefore, the stable communication efficiency between the LSI circuits can be attained. Also, because it is not necessary to perform a strict waveform simulation in designing a signal transmission route such as a printed circuit board and a connector, a design period can be shortened. Moreover, there is an effect that a risk of revision of the printed circuit board after evaluation of an actual unit is eliminated and that a cost for the revision of the printed circuit board can be reduced, because the error correction can be performed.

### Second Exemplary Embodiment

Next, the digital data transmission system according to a second exemplary embodiment of the present invention will be described.

The digital data transmission system of the present exemplary embodiment differs from the first exemplary embodiment in the configuration of the data stored in the data storage areas of the deskew data for the data lines. Therefore, the description is made with respect to a portion which is different from the first exemplary embodiment and then description of the same portion is omitted.

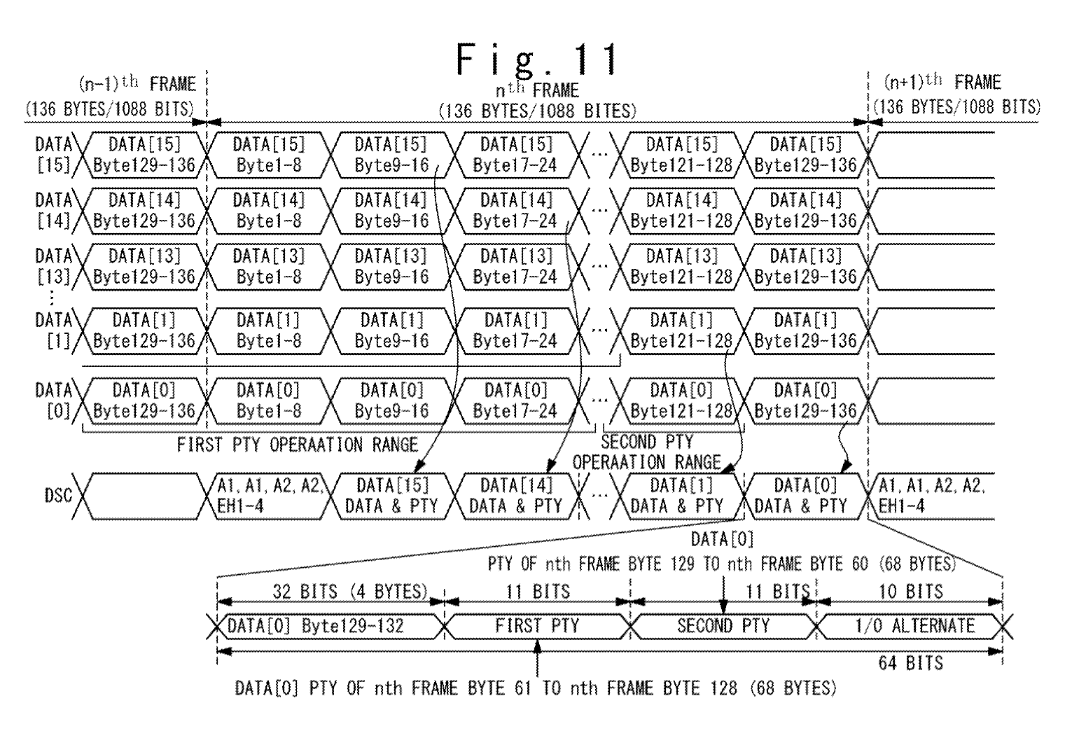

FIG. 11 shows timing charts of the digital data and the deskew data in the digital data transmission system of the present exemplary embodiment. In FIG. 11, DATA[15] to DATA[0] show digital data on the data lines. Also, DSC shows the deskew data on the deskew signal line. In the SFI-5 standard, a framing is performed for every 136 bytes (1088 bits) of the digital data and the deskew data.

Data is stored in the data storage area of the deskew data in units of 64 bits for each of the data lines, like the first exemplary embodiment. In the present exemplary embodiment, the sample data (32 bits) for each data line, first parity data (11 bits) and second parity data (11 bits) are stored in the data storage area. It should be noted that it is desirable that the alternate pattern of “1” and “0” is stored the remaining 10 bits as unused bits so as to avoid continuation of identical code.

The data storage areas of the deskew data for the data lines in the n″ frame are shown in FIG. 9. “Byte129 to Byte132” as the sample data are first stored in the data storage area from the digital data for the data DATA[0]. Next, there are stored the first parity data for 68 bytes and the second parity data (11 bits) for 68 bytes, among the digital data for one frame (136 bytes) immediately before the stored sample data. That is, the first parity data (11 bits) is calculated based on 68 bytes from “Byte129” of the digital data for the data DATA[0] in the (n−1)^{th} frame to “Byte60” in the n^{th} frame. Also, the second parity data is calculated from the 68 bytes from “Byte61” of the digital data for the data DATA[0] in the n^{th} frame to “Byte128” in the n^{th} frame. Moreover, an alternate pattern of “1” and “0” is stored as the unused 10 bits. In this way, the deskew data is generated for the data lines in the n^{th} frame.

The deskew data for another data line is generated in the same way. For example, 32 bits of “Byte9 to Byte12” are first stored in the data storage area for the data DATA[15] which is inserted immediately after the header of the deskew data as the sample data obtained from the digital data for the data DATA[15]. Next, the first parity data of 11 bits is calculated and stored based on 68 bytes from “Byte9” of the digital data for the data DATA[15] in the (n−1)^{th} frame to “Byte76” of the n^{th} frame, and the second parity data of 11 bits is calculated and stored based on 68 bytes from “Byte77” of the digital data for the data DATA[15] in the (n−1)^{th} frame to “Byte8” of the n^{th} frame. Moreover, the alternate pattern of “1” and “0” is stored in unused 10 bits.

In the present exemplary embodiment, like the first exemplary embodiment, the Hamming code may be used for the code correction method. The Hamming code can be used for a 1-bit error correction of the tested data. Also, the Hamming code can be used to detect a 2-bit error but cannot be used to correct it. Referring to FIG. 10, when the parity data is calculated based on 544 bits (68 bytes) immediately before the sample data like the present exemplary embodiment, it can be confirmed to be sufficient that the bit length of the Hamming code is 11 bits.

The framing controller section 14 of the transmission LSI circuit 1 in the present exemplary embodiment controls the sample data extracting section 15 to select one of the data lines to extract the sample data and to extract the 32-bit sample data. Also, the framing controller section 14 specifies two ranges of 544 bits as 1088 bits for one frame immediately before the sample data by the parity operation start signal and the parity operation range signal and controls the parity operation sections 13 to calculate parity data. Then, the framing controller section 14 controls the sample data extracting section 15 and the deskew data output section 16 to output onto the deskew signal line, the 32-bit sample data, and then the 11-bit first parity data, the 11-bit second parity data and the 10-bit alternate pattern of “1” and “0” as unused bits. In this way, the framing controller section 14 controls the FEC encoder section 12, the sample data extracting section 15 and the deskew controller output section 16 to transmits one frame of the deskew data DSC to the deskew signal line.

Also, the FEC decoder section 27 of the reception LSI circuit 2 receives the recovered digital data and the deskew data from the CDR section 21. The reception parity operation sections 28 of the FEC decoder section 27 extracts the first parity data and the second parity data of the recovered digital data for each data line from the deskew data. Also, the reception parity operation sections 28 receive the recovered digital data for the data lines from the CDR section 21.

The reception parity operation sections 28 calculates the first parity data and the second parity data from the recovered digital data based on the parity operation range signal and the parity operation start signal outputted from the deskew controller section 25. Then, the reception parity operation sections 28 compares the calculated first parity data and the first parity data acquired from the deskew data and compares the calculated second parity data and the second parity PTY acquired from the deskew data. The reception parity operation sections 28 outputs the error determination result to the correction processing section 29 to indicate “no error” in the recovered digital data, when the comparison result shows coincidence, and outputs the error determination result to the correction processing section 29 to indicate “error existence” in the recovered digital data, when the comparison result shows non-coincidence.

The decoder 30 in the correction processing section 29 receives the error determination result to the recovered digital data for the data lines from the FEC decoder section 27. The decoder 30 specifies the location of an error generated in the recovered digital data based on the error determination result when the error determination result indicates that there is an error. Then, the decoder 30 outputs the decoding result to the adder 31 to indicate the error location in a bit string of the recovered digital data.

The adder 31 receives the recovered digital data subjected to the deskew processing from the variable delay section 26 and the decoding result from the decoder 30. The adder 31 inverts the error location bit indicated by the decoding result and the data to the reception core logic section 24.

It should be noted that the configuration and operation other than the matters mentioned above are same as the first exemplary embodiment.

In this way, at the present exemplary embodiment, the parity data is calculated for every 68 bytes to the digital data signal as tested data for one frame (136 bytes). Therefore, one bit correction to 136 bytes (1088 bits) is possible in the first exemplary embodiment, whereas in the present exemplary embodiment, the 1-bit correction to 68 bytes (544 bits) is possible. Therefore, a correct ability of the digital data transmission system is improved.

It should be noted that in the present exemplary embodiment, one frame is divided into 2 parts, but the one frame may be divided into 3 or 4 parts. As shown in FIG. 10, according to the bit length necessary for the parity data, the bit length of the sample data and the bit length of the unused bit can be changed. Also, the error correction method is not limit to the Hamming code. Another error correction method may be used.

As described above, the present invention has been described with reference to the exemplary embodiments, but the present invention is not limited to the above exemplary embodiments. It could be understood that various modifications can be made in the configuration in the scope of the present invention.

What is claimed is:

1. A digital data transmission system comprising a transmission unit and a reception unit,
wherein said transmission unit comprises:
a transmission-side logic section configured to transmit digital data in parallel onto data lines; and
a deskew data generating section configured to transmit deskew data onto a deskew signal line,
wherein said deskew data includes sample data and parity data for each of line components of the digital data,
wherein said reception unit comprises:
a skew adjusting section configured to perform deskew processing on the digital data recovered from the data transmitted on said data lines based on the deskew data recovered from The data transmitted on said deskew signal line;
an error correcting section configured to perform error correction on the recovered digital data subjected to the deskew processing based on the parity data of the recovered deskew data; and
a reception-side logic section configured to execute a predetermined process to the recovered digital data subjected to the error correction.

2. The digital data transmission system according to claim 1, wherein said deskew data generating section stores the sample data and the parity data for each line component in a corresponding one of data storage areas of the deskew data.

3. The digital data transmission system according to claim 2, wherein said deskew data generating section calculates the parity data based on the digital data for one frame immediately before the sample data corresponding to the parity data.

4. The digital data transmission system according to claim 3, wherein said deskew data generating section calculates a portion of the parity data for each of divisions of the digital data for one frame immediately before the sample data.

5. The digital data transmission system according to claim 1, wherein said deskew data generating section comprises:
an encoder section configured to calculate the parity data from each line component of the digital data;
a sample data extracting section configured to extract the sample data from each line component of the digital data;
a framing controller configured to output a header of the deskew data;
a deskew data output section configured to select the header and sets of the sample data and the parity data and transmit the selected data onto said deskew signal line.

6. The digital data transmission system according to claim 5, wherein said error correcting section comprises:
a decoder section configured to calculate parity data from the recovered digital data, extract the parity data from the recovered deskew data, and detect an error in the recovered digital data based on the extracted parity data and the calculated parity data; and
a correction processing section configured to correct the recovered digital data subjected to the deskew processing based on the error detected by said decoder section.

7. The digital data transmission system according to claim 5, wherein said framing controller outputs a calculation range specification signal,
wherein said encoder section comprises a plurality of parity operation sections provided for the line components, wherein each of said plurality of parity operation sections calculates the parity data from the digital data in a range specified by the calculation range specification signal.

8. The digital data transmission system according to claim 6, wherein said decoder section comprises a plurality of reception parity operation sections provided for said data lines, and
wherein each of said plurality of reception parity operation sections calculates the parity data from the recovered digital data in a specified calculation range, and detects the error of the recovered digital data based on the extracted parity data and the calculated parity data.

9. The digital data transmission system according to claim 6, wherein said correction processing section comprises:
an error decoder provided for each of the line component, and configured to specify a location of the error in a portion of the recovered digital data corresponding to the line component; and
an adder provided for each of said error decoders and configured to correct the recovered digital data based on the specified location.

10. A transmitting unit comprising:
a transmission-side logic section configured to transmit digital data in parallel onto data lines; and
a deskew data generating section configured to transmit deskew data onto a deskew signal line,
wherein said deskew data includes sample data and parity data for each of line components of the digital data.

11. A digital data processing method comprising:
transmitting digital data in parallel onto data lines;
transmitting deskew data onto a deskew data line;
wherein the deskew data comprises sets of sample data and parity data for each of line components of the digital data;
performing deskew processing on digital data recovered from data transmitted on said data lines based on the sample data;
correcting the recovered digital data subjected to the deskew processing based on the parity data; and
executing predetermined processing to the corrected digital data.

12. The digital data processing method according to claim 11, wherein said transmitting deskew data comprises:
storing the sample data and the parity data in a corresponding one of a plurality of data storage areas of the deskew data.

13. The digital data processing method according to claim 12, wherein said storing the sample data and the parity data comprises:
calculating the parity data from the digital data for one frame immediately before the sample data.

14. The digital data processing method according to claim 13, wherein said calculating the parity data comprises:
calculating a portion of the parity data from each of divisions of the digital data for one frame immediately before the sample data for each data line.
